(19) United States
(12) Patent Application Publication
(10) Pub. No.: US 2009/0315916 A1
(43) Pub. Date: Dec. 24, 2009

(54) ON-THE-FLY CREATION OF VIRTUAL PLACES IN VIRTUAL WORLDS

(75) Inventors: Dirk Husemann, Einsiedeln (CH); Samuel Muller, Zurich (CH); Michael Elton Nidd, Zurich (CH); Matthias Schunter, Zurich (CH); Diego M. Zamboni, Adliswil (CH)

Correspondence Address: RYAN, MASON & LEWIS, LLP, Suite 205, 1300 Post Road, Fairfield, CT, 06824, US

(73) Assignee: International Business Machines Corporation, Armonk, NY (US)

(21) Appl. No.: 12/145,081

(22) Filed: Jun. 24, 2008

(51) Int. Cl. G06Q 30/00; G06F 3/048

(52) U.S. Cl. 345/633; 715/850

(57) ABSTRACT

A specification of a set of objects associated with at least one virtual world is obtained. The objects are laid out in a three-dimensional virtual representation. An on-the-fly virtual place is created in the virtual world, based on the layout. The virtual place depicts the set of objects in the three-dimensional virtual representation and enables navigation and interaction therewith

### FIELD OF THE INVENTION

The present invention relates to the electrical, electronic and computer arts, and, more particularly, to computer user communities and the like

### BACKGROUND OF THE INVENTION

So-called virtual worlds (computer-based simulated environments) have recently gained in popularity. Such worlds may be inhabited by users, who interact via avatars. Currently in virtual worlds (such as Second Life, Active Worlds or There), the only way to access objects located in distant places of the virtual world is to travel to their location. This is consistent with the idea of a virtual world, but it makes certain activities (such as reviewing search results, or completing a sequence of related activities) cumbersome and complicated by the need to travel to the geographical location of each object in the virtual world.

As an example, a user shopping for (real or virtual) shoes in the virtual world might do a search for “shoe shop” in the Second Life search facility, resulting in a large list of pointers to existing stores. The list provides no detailed information about each store, so the user has to travel to each location in sequence to be able to evaluate each location's offers, to interact with other avatars, and to make an informed decision.

### SUMMARY OF THE INVENTION

Principles of the present invention provide techniques for on-the-fly creation of virtual places in virtual worlds. In one aspect, an exemplary method (which can be computer implemented) includes the steps of: obtaining a specification of a set of objects associated with at least one virtual world; laying out the objects in a three-dimensional virtual representation; and creating an on-the-fly virtual place in the virtual world, based on the laying out step, the virtual place depicting the set of objects in the three-dimensional virtual representation and enabling navigation and interaction therewith.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

One or more embodiments of the invention may offer one or more of the following technical benefits:
Improved ease and efficiency of navigation in the virtual world
Improved communication and cooperation among users of the virtual world
Improved visibility and accessibility of resources in the virtual world, by representing them in their original form (3-dimensional views instead of textual representations) and in a consistent context (e g. all objects next to one another instead of as links to separate places that must be individually visited).

These and other features, aspects and advantages of the present invention will become apparent from the following detailed description of illustrative embodiments thereof, which is to be read in connection with the accompanying drawings

### BRIEF DESCRIPTION OF THE DRAWINGS

FIG. 1 shows a virtual place in the form of a virtual street, in accordance with an aspect of the invention;

FIG. 2 shows a flow chart of steps in an exemplary method, according to another aspect of the invention;

FIG. 3 shows a virtual place in the form of a virtual tower, in accordance with still another aspect of the invention;

FIG. 4 shows a virtual place in the form of a virtual tunnel, in accordance with yet another aspect of the invention;

FIG. 5 shows a virtual place in the form of a virtual mall, in accordance with a further aspect of the invention;

FIG. 6 shows a virtual world server and user computers interacting therewith, according to exemplary techniques of the invention;

FIG. 7 shows a virtual store, according to a still farther aspect of the invention;

FIG. 8 shows techniques to allow a virtual place to be created from objects located in more than one virtual world, according to an even further aspect of the invention;

FIG. 9 is a detailed flow chart showing one specific detailed instance of the method of FIG. 2;

FIG. 10 depicts a computer system that may be useful in implementing one or more aspects and/or elements of the present invention; and

FIG. 11 depicts wallpaper objects, according to yet a further aspect of the invention.

### DETAILED DESCRIPTION OF PREFERRED EMBODIMENT

One or more embodiments of the invention provide techniques for accessing geographically-dispersed objects or places (both of which are referred to generically herein as “objects”) in virtual worlds in a convenient fashion. One or more instances of the invention provide a special display service for virtual worlds, wherein collections of virtual places or objects are represented as a “virtual place” inside the virtual world, created on the fly. The collections of virtual places or objects may be, for example, search results or collections determined by some other criteria, such as a list of objects needed to complete a certain task. The on-the-fly virtual place can be implemented in different ways and can take the form of, for example, a street, a building, or any other appropriate structure In this manner, the user can explore the results inside the virtual world, interacting directly with the appropriate places or objects

Note that a virtual universe may include several virtual worlds, each containing objects and places, but topologically disjoint (i.e. no contiguous path exists between points in the two regions) from the others. Conceptually, one could see an entire virtual world as an object within a virtual universe though. In this case, virtual world and virtual universe would denote the same. For purposes of this disclosure, the terminology “virtual world” is adopted for consistency.

As used herein, “on-the-fly” creation of the virtual place refer's to the fact that the virtual place is populated dynamically with the objects in the collection, and may be changed as the set changes, or by user control. The on-the-fly virtual place does not contain real objects, but rather virtual “images” of objects in other places of the virtual world, which are, on the fly, presented in the on-the-fly virtual place (OFVP), although they still exist at their original place.

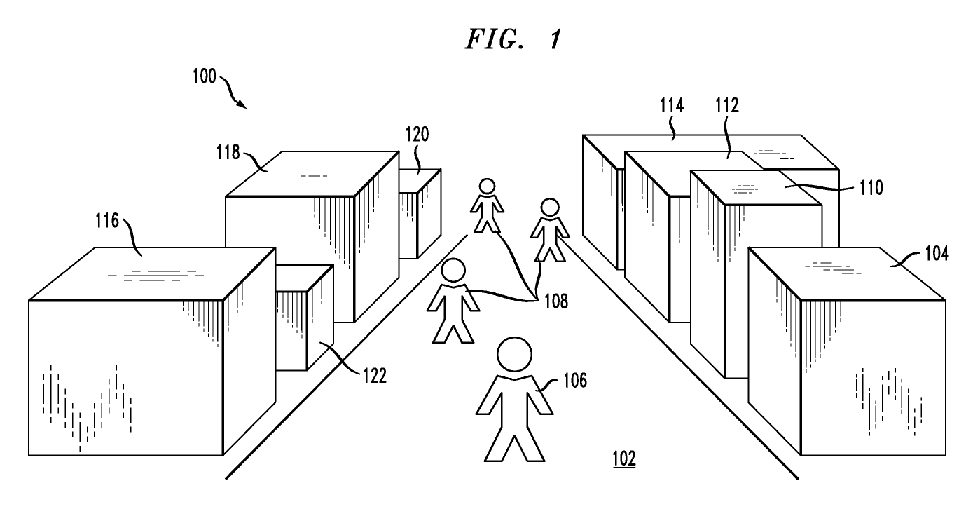

A non-limiting example is provided in the context of a search for “shoe shop.” In current virtual worlds, such a search may result in numerous “hits” which may not be well-organized in a manner convenient for the user. In an exemplary embodiment 100 of the invention, as seen in FIG. 1, the search for “shoe shop” results in the creation of a new virtual street 102 containing all the shoe shops found; in this example, 104, 110, 112, 114, 116, 122, 118, 120, and the user 106 could walk down the street 102 looking at them to decide which one to enter. The ability to look at the actual shops (as opposed to merely their names) side-by-side helps the user in making an informed decision.

By utilizing semantic information about the objects, the on-the-fly virtual places corresponding to semantically-related sets can be merged by the server that is running the virtual world software, so that each user is not alone in his virtual place, but rather can interact with other users of similar interests; for example, users 108. In this manner, on-the-fly virtual places help not only individual users 106, but can also help create communities of related interests. In one or more instances of the invention, users have the ability to specify whether a new on-the-fly virtual place, such as street 102, is to be private (in which case only user 106 has access) or shared (in which case other users 108 also have access, as in FIG. 1).

Still with reference to FIG. 1, in some instances, the server creates a single virtual street 102 for all the users that have performed searches for shoe shops at the moment, helping to create an improved social experience. Users, such as user 106, may then ask other avatars, such as avatars 108, wandering around in the virtual place for comments about a certain product that they have just bought. Furthermore, using semantic information about the shops, other establishments of possible relevance (such as shoe accessories or other clothing items) could be put on the same street, providing additional information to the users.

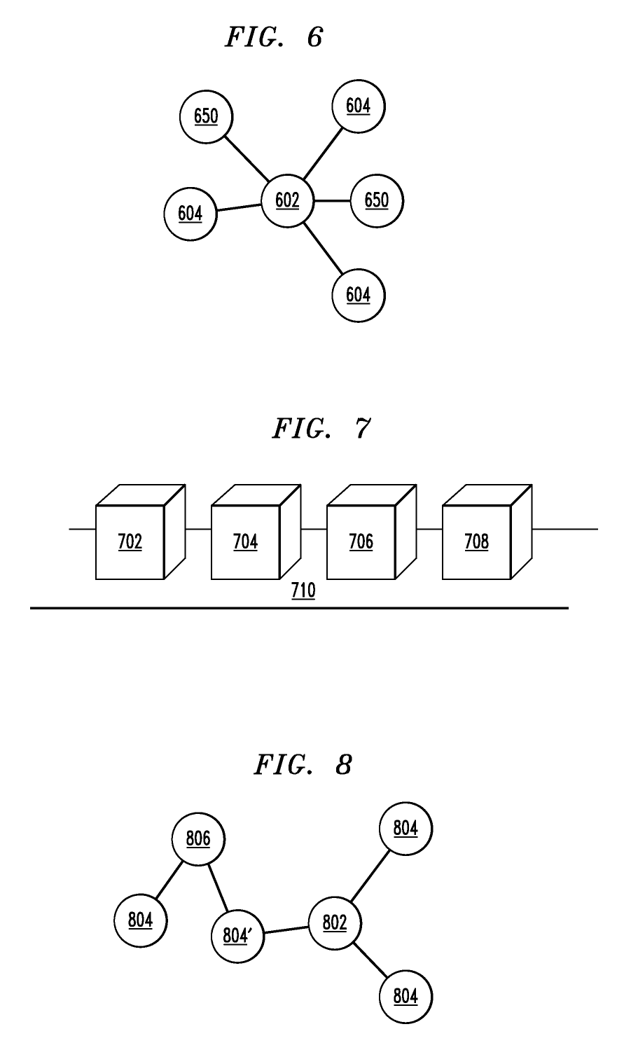

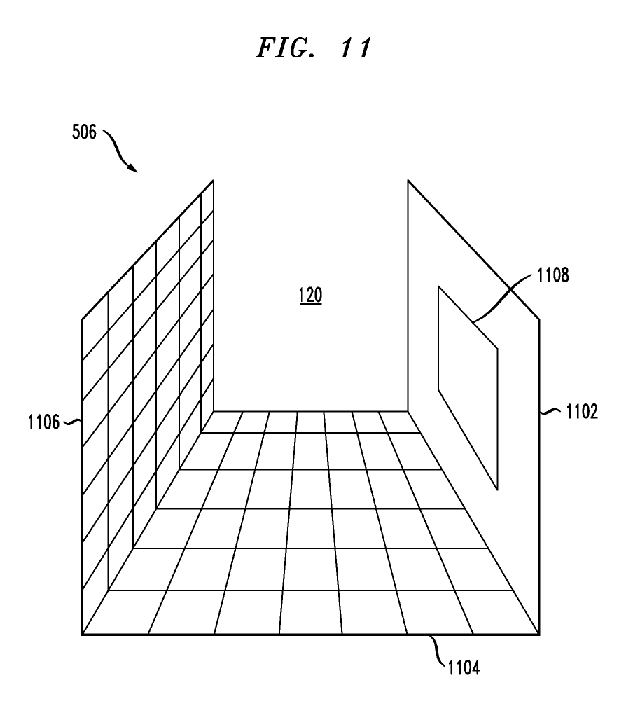

By interacting within a virtual place, such as street 102, avatars may directly change the virtual place. In one or mole embodiments of the invention, this functionality is implemented by feedback loops from the search and display engines of the virtual world to the content providers, and vice versa. This is discussed farther below with regard to FIGS. 6 and 10

Consider a user who has searched for shoe shops and then walks down a custom-generated virtual street 102 with his avatar 106. If the user shows a particular interest for red hiking boots by looking at a number of them in series (possibly in different shops), the arrangement of shops on the street as well as the display of products offered can be changed accordingly, for example, by displaying more red shoes in the windows or by presenting special deals, such as offering discounts and related accessories. The user 106 could also directly specify changes to be made (for example, shops to be added or removed from the virtual street).

Such a malleable representation, as offered by one or more embodiments of the invention, helps users achieve better interaction with objects and places in which they have an interest, as well as assisting with interaction and collaboration with other users in the virtual world.

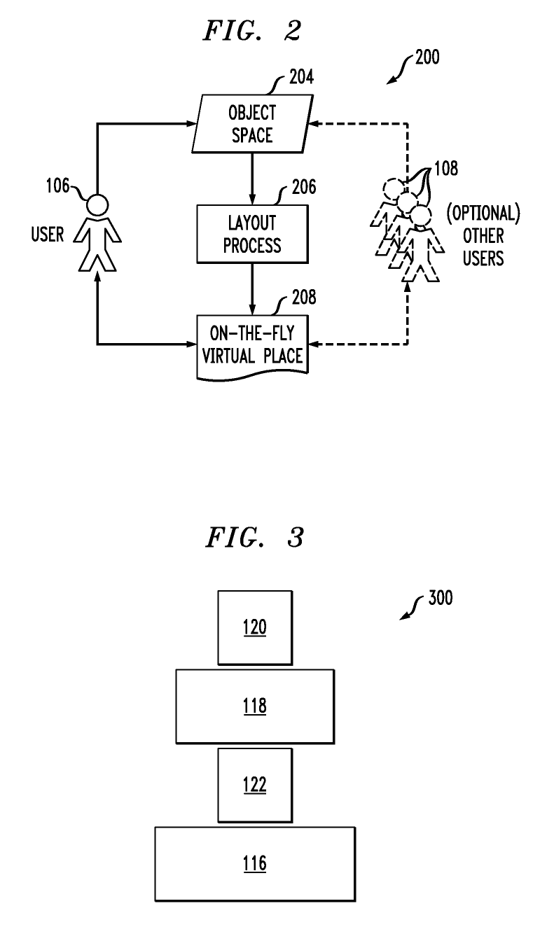

Reference should now be had to FIG. 2, which presents a flow chart 200 with steps in an exemplary method, according to an aspect of the invention In block 204, user 106 specifies a set of objects (from a given object space) to represent. In block 206, the objects are laid out in a three-dimensional representation by a layout process. In block 208, an on-the-fly virtual place is created in the virtual world. The user 106 can navigate and interact with the on-the-fly virtual place. Optionally, other users 108 can be given permission to visit the on-the-fly virtual place (for example, street 102 in FIG. 1), or to modify the object space themselves (that is, users 108 can modify the set of objects represented in the virtual place). Each step 204, 206, 208 can be carried out in a number of different ways; non-limiting examples will now be provided.

With regard to specification of the object space in step 204, the set of objects to represent can be specified in a number of different fashions. In some instances, the specification can be done manually, with the user indicating each individual object in the set. In another approach, the specification can be performed via criteria, with the user specifying criteria that the objects in the set must satisfy. Possible criteria include, but are not limited to: searching for terms that appear in the object name or description (for example, all objects that contain “shoe shop” in their name or description); geographical criteria (for example all objects within certain geographical boundaries in the virtual world); criteria based on object characteristics such as size, shape, color or texture (for example, all red objects); and criteria based on object metadata such as ownership or semantic categorizations (for example, all shops categorized as clothing shops). Furthermore, the specification may employ combinations of any two or more of the preceding approaches. The specification of the object set can be performed by an individual user or by multiple users in collaboration, and the object space can contain both places (for example virtual buildings) and other objects (for example, virtual books, shoes or furniture) (stated in another way, the object set can include both virtual locations and virtual individual objects).

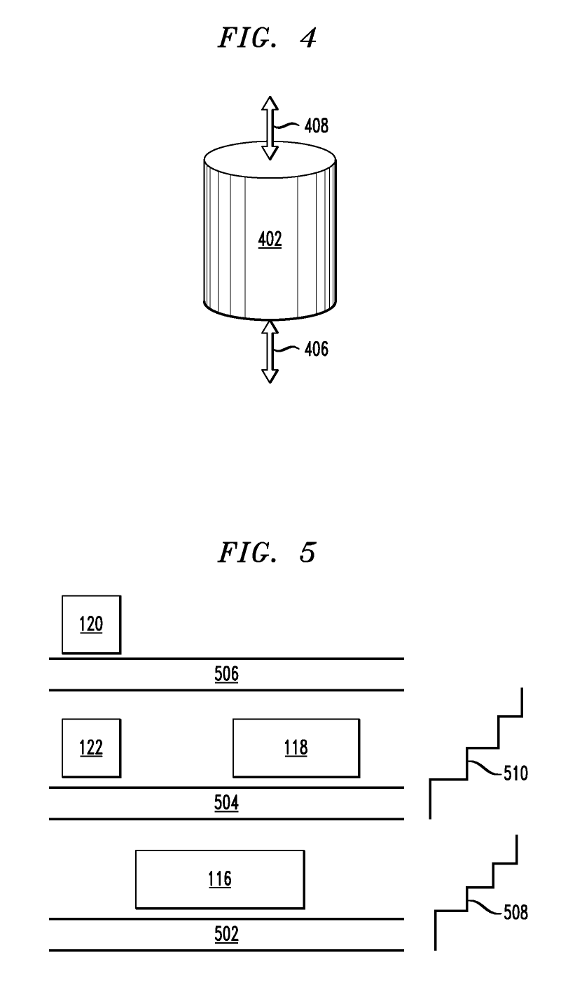

With regard to the layout process in step 206, objects contained in the object space can be laid out in a virtual three-dimensional space in a number of different ways. As shown in FIG. 1, the objects can be laid out in a virtual street 102, in which the objects are placed along one side of the street or, as in FIG. 1, on both sides of the street. In other instances, the objects can be laid out in a virtual tower 300, as shown in FIG. 3, in which the objects are placed on top of each other. Note that similar reference characters refer to similar items in the figures. The objects 116, 122, 118, 120 can be accessible from the outside of the tower, as shown in FIG. 3. In still other instances, as shown in FIG. 4, the objects can be accessible from the inside of the tower, for example, with a vertical tunnel 402 around which the objects are placed and through which the user can navigate, as indicated by double-headed arrows 406, 408. In further instances, the user may engage in direct traversal from one place to another (for example, from shop 104 to shop 110). In this case, the user visits the first place in the set, say, shop 104. Upon exiting it, the user travels automatically to the next object in the set, say, shop 110, and so forth. This case is of interest when the objects in the set are virtual places that can actually be visited. In yet further instances, such as depicted in FIG. 5, the objects can be laid out in a complex structure, such as a “virtual mall,” with hallways 502, 504, 506, stairs 508, 510, and other structures, which allow the user to navigate within the on-the-fly virtual place. In general terms, a virtual mall can have at least two hallways (which can be, in at least some instances, on different virtual floors) and at least one transition between the at least two hallways (for example, intersections, stairs, elevators, escalators, and the like).

The positioning of the objects in the on-the-fly virtual place can, in at least some instances, have semantic meaning. Non-limiting examples of such semantic meaning include the following: (i) objects laid out according to their relevance to the search terms, so that objects with higher relevance are closer to the user; (ii) objects laid out according to semantic groupings, so that (for example) similar shops are grouped together in a virtual mall; and (iii) objects laid out according to user preferences or commercial interests (for example, a service could be offered to merchants to allow them to obtain “preferential location” in on-the-fly virtual places, responsive to payment of an advertising fee to an operator of the virtual world or related service). In case (i), in FIG. 1, shops 104, 116 maybe the most relevant. In case (ii), in FIG. 5, shops 116, 118, 120, 122 may be similar types of shops. In case (i), in FIG. 1, shops 104, 116 may have paid an advertising fee for the prominent location.

With regard to step 208 in FIG. 2, the actual creation of the on-the-fly virtual places can be done through a number of different techniques. The following are non-limiting examples. With reference to FIG. 6, in some instances, on-the-fly virtual places are created by the server 602 of the virtual world, for example in a specific “virtual place island,” or on virtual land created on-demand by the server. The server 602 controls who can access the virtual place, with the possibility of making it private or shared. In other instances, on-the-fly virtual places are created and managed by the user's client software, residing on user machines 604. In this case the server 602 would have no knowledge of the on-the-fly virtual place, although other user's could still access it via peer-to-peer communication mechanisms among user machines 604. Server 602 and user machines 604 may be connected by a suitable network or “network of networks,” such as the worldwide, publicly accessible series of interconnected computer networks that transmit data by packet switching using the standard Internet Protocol (IP), commonly referred to as the Internet.

As noted above, by interacting within a virtual place, such as street 102, avatars may directly change the virtual place. In one or more embodiments of the invention, this functionality is implemented by feedback loops from the search and display engines of the virtual world to the content providers, and vice versa. In particular, server 602 and user computers 604 may have processor's and memories similar to those discussed in FIG. 10 below. The memory of server 602 may contain instructions for the processor of server 602 to run one or more search engine(s) and/or one or more display engine(s) (such functionality may also reside on the user computers 604). The results of searches and/or user input to display engines can be provided to content providers 650 for appropriate action.

The user interaction with on-the-fly virtual places can take multiple forms, including but not limited to the following: (i) simple navigation through the virtual place, in which the user can examine or visit the objects in it; (ii) ability to rearrange objects in the virtual place, for example, to group them according to user preferences; (iii) ability to modify the object space on the fly (for example, add and/or remove individual objects, or modify the object space criteria), with changes reflecting immediately in the on-the-fly virtual place. Interaction can be limited to a single user, or can be granted to groups of users for collaboration. An example of case (ii) would be allowing a user to move shop 118 in FIG. 5 to an upper floor serviced by aisle 506 instead of aisle 504. An example of case (iii) would be as follows. Suppose FIG. 1 shows all shops that turn up when “shoe shops” are searched. Now, the user decides that he or she is only interested in sports shoe shops, so the search criteria are narrowed, and shops 120 and 110 disappear. Next, the user notes that shop 118 is a factory outlet for “Acme” shoes, with which the user has previously had an unsatisfactory experience. Thus, the user deletes the shop 118 from the on-the-fly virtual place.

In one or more embodiments, the on-the-fly virtual place can represent objects at different granularities. At the highest level, entire buildings could be represented, providing the user the ability to visit any of the buildings in the set, as shown in FIG. 1. At the other end, as shown in FIG. 7, individual objects in the virtual world could be represented (allowing, for example, the user to create a “virtual store” containing only red shoes from different places in the virtual world). In FIG. 7, boxes 702, 704, 706, 708 containing red shoes from four different shops are displayed on a single shelf 710. Of course, the actual shoes could be displayed, but the boxes are shown in the figure for illustrative convenience. The layout, navigation and interaction possibilities are different depending on the level of granularity being used.

In some instances, on-the-fly virtual places could potentially gather objects from multiple virtual world systems For example, in FIG. 8, a number of users 804 access two servers 802, 806, each server running a different virtual world. At least one user 804′ accesses both virtual worlds and can locally gather objects from both worlds 802, 806 into a single virtual place, which can then be peer-to-peer shared with other users 804. As above, the on-the-fly virtual place could be created, provided, and shared by the server of one of the virtual worlds or by a dedicated server that integrates the objects from the various virtual worlds involved and that distributes and/or coordinates the interaction between user and content providers.

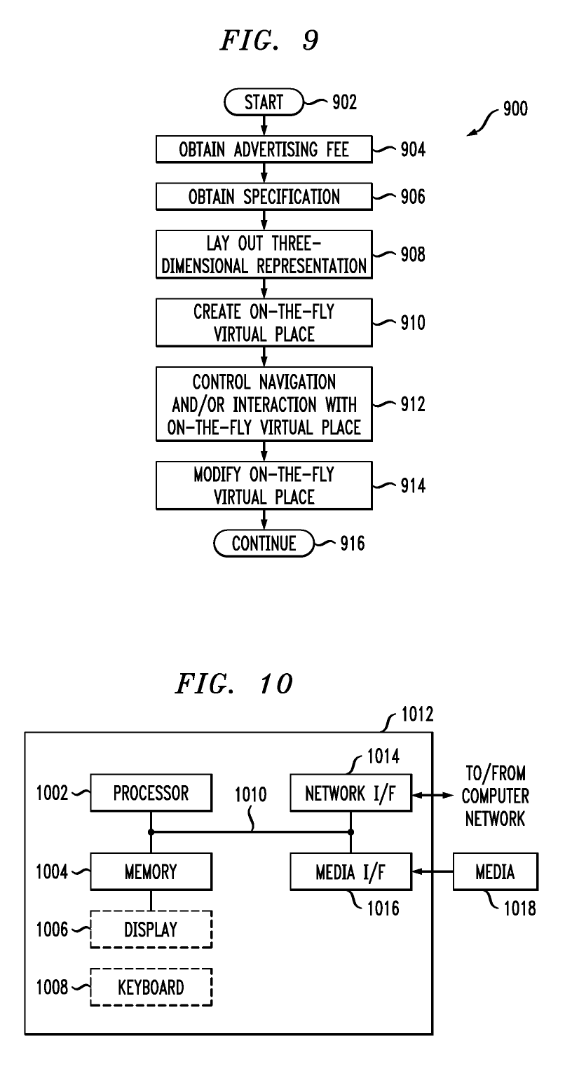

By way of review and provision of additional detail, consider the flow chart 900 of FIG. 9, which depicts a specific detailed instance of the method of FIG. 2. An exemplary method, according to an aspect of the invention, includes the steps of obtaining a specification of a set of objects associated with at least one virtual world, as at step 906; laying out the objects in a three-dimensional virtual representation, as in step 908; and creating an on-the-fly virtual place in the virtual world, based on the laying out step, as at step 910. The virtual place depicts the set of objects in the three-dimensional virtual representation and enables navigation and interaction therewith. It will be appreciated that steps 906, 908, 910 are analogous to steps 204, 206, and 208 in FIG. 2. The steps in FIGS. 2 and 9 can be carried out, for example, by software on a server 602, 802, 806 and/or software on a user computer 604, 804, 804′.

In the detailed method of FIG. 9, one or more optional steps can be performed After beginning at step 902, an advertising fee can be obtained in block 904, for purposes discussed below. Step 912 includes controlling navigation and/or interaction with the virtual place. For example, in some instances, the specification in step 906 is obtained from a single user, and step 912 includes limiting the navigation and interaction to the single user. To clarify, the specification includes both the specified objects as well as the layout, e.g., street. In other instances, while the specification is obtained from a single user; the step 912 includes allowing the navigation and interaction to the single user as well as at least one additional user. In still other instances, the specification is obtained from multiple users, and step 912 includes allowing the navigation and interaction to the multiple users.

Step 914 includes on-the-fly modification of the virtual place. For example, step 914 could include allowing at least one user to modify the set of objects subsequent to the creation of the virtual place. In some cases, the interaction includes obtaining input from a user of the virtual place. The user input specifies, for example, one or more of: addition of removal of, and rearrangement of, the objects in the virtual place; modification in step 914 can be based on such input.

As noted elsewhere, in some instances, in the laying out step 908, positioning of the objects has semantic meaning. In some embodiments, optional additional step 904 includes obtaining an advertising fee from an entity associated one or more of the objects. In such a case, the semantic meaning is such that the object (or objects) with which the entity paying the fee is associated is displayed in a more prominent position in the virtual place than other objects.

Processing Continues at 916.

With reference to FIG. 11, in another aspect, the obtaining of the specification in step 906 includes inclusion of wallpaper objects. As user herein, “wallpaper objects” include objects that are not directly part of a search result, but ate necessary, or at least helpful, to produce a useful layout, including (but not limited to) walls, scenery, and decorations. Such wallpaper objects may be chosen, for example, according to user preferences, and/or according to server configuration (including sponsorship). In some instances, the wallpaper objects are chosen according to a combination of two or more of user-specific information (including preferences and past behavior), user selections (such as search criteria), and server configuration (including sponsorship). Thus, in some instances, the wallpaper objects can be chosen according to past user behavior or their display can be functionally dependent on the initial search criteria (and in addition, based on user preferences, as well).

If the layout of the virtual place (for example, the mall hallways, such as hallway 506) includes such wallpaper objects (for example walls 1102 and 1106 and a floor 1104) that are not necessarily actual objects in any of the virtual worlds, such objects might be selected, for example, according to either user preferences (castle hallway, forest path, Champs-Élysées, and so on) or sponsorship (search-site logo posters, advertiser logos, carpet color to match preferred suppliers, and the like). In the non-limiting example of FIG. 11, shop 120 is at the end of hallway 506. The floor 1104 and wall 1106 are depicted as stone, to simulate a castle hallway, while wall 1102 has an advertisement 1108. Of course, shops could be on the side of hallways as well as the end.

### Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to per form exemplary method steps.

One or more embodiments can make use of software running on a general purpose computer or workstation. With reference to FIG. 10, such an implementation might employ, for example, a processor 1002, a memory 1004, and an input/output interface formed, for example, by a display 1006 and a keyboard 1008. The term “processor” as used herein is intended to include any processing device, such as, for example, one that includes a CPU (central processing unit) and/or other forms of processing circuitry. Further, the term “processor” may refer to mote than one individual processor. In connection with FIG. 10, the term “memory” is intended to include memory associated with a processor or, CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1002, memory 1004, and input/output interface such as display 1006 and keyboard 1008 can be interconnected, for example, via bus 1010 as part of a data processing unit 1012. Suitable interconnections, for example via bus 1010, can also be provided to a network interface 1014, such as a network card, which can be provided to interface with a computer network, and to a media interface 1016, such as a diskette or CD-ROM drive, which can be provided to interface with media 1018. FIG. 10 is illustrative of the servers and other computers mentioned herein.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 1018) providing program code for use by or in connection with a computer or any instruction execution system. For the purposes of this description, a computer usable of computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device). Examples of a computer-readable medium include a semiconductor or solid-state memory (for example memory 1004), magnetic tape, a removable computer diskette (for example media 1018), a random access memory (RAM), a read-only memory (ROM), a rigid magnetic disk and an optical disk. Current examples of optical disks include compact disk-read only memory (CD-ROM), compact disk-read/write (CD-RAW) and DVD.

A data processing system suitable for storing and/or executing program code will include at least one processor 1002 coupled directly or indirectly to memory elements 1004 through a system bus 1010. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 1008, displays 1006, pointing devices, and the like) can be coupled to the system either directly (such as via bus 1010) or through intervening I/O controllers (omitted for clarity).

Network adapters such as network interface 1014 may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer of other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
obtaining a specification of a set of objects associated with at least one virtual world;
laying out said objects in a three-dimensional virtual representation; and
creating an on-the-fly virtual place in said virtual world, based on said laying out step, said virtual place depicting said set of objects in said three-dimensional virtual representation and enabling navigation and interaction therewith.

2. The method of claim 1, wherein said specification is obtained from a single user, further comprising the additional step of limiting said navigation and interaction to said single user.

3. The method of claim 1, wherein said specification is obtained from a single user, further comprising the additional step of allowing said navigation and interaction to said single user as well as at least one additional user.

4. The method of claim 1, wherein said specification is obtained from multiple users, further comprising the additional step of allowing said navigation and interaction to said multiple users.

5. The method of claim 1, wherein said specification is obtained from at least one user, further comprising the additional step of allowing said at least one user to modify said set of objects subsequent to said creation of said virtual place.

6. The method of claim 1, wherein said obtaining of said specification comprises manual specification by at least one user.

7. The method of claim 1, wherein said obtaining of said specification comprises obtaining, from at least one user, at least one criterion to be satisfied by said objects.

8. The method of claim 7, wherein said at least one criterion comprises a search term to appear in at least one of a description and a name for each of said objects.

9. The method of claim 7, wherein said at least one criterion comprises a geographical criterion.

10. The method of claim 7, wherein said at least one criterion is based on object characteristics.

11. The method of claim 10, wherein said characteristics in turn comprise at least one of size, shape, color and texture.

12. The method of claim 1, wherein said obtaining of said specification comprises at least inclusion of wallpaper objects.

13. The method of claim 12, wherein said wallpaper objects arc chosen according to at least one of user-specific information, user selections, and server configuration.

14. The method of claim 1, wherein said objects comprise at least virtual locations and virtual individual objects.

15. The method of claim 1, wherein said laying out comprises forming at least one of a virtual street and a virtual tower.

16. The method of claim 1, wherein said laying out comprises forming a virtual mall having at least two hallways and at least one transition between said at least two hallways.

17. The method of claim 1, wherein said objects comprise virtual locations and wherein said laying out comprises arranging said objects for direct traversal.

18. The method of claim 1, wherein, in said laying out, positioning of said objects has semantic meaning.

19. The method of claim 18 wherein said semantic meaning is such that those of said objects with higher relevance are closer to a user of said virtual place.

20. The method of claim 18, further comprising the additional step of obtaining an advertising fee from an entity associated with at least one of said objects, wherein said semantic meaning is such that said at least one of said objects is displayed in a more prominent position in said virtual place than other ones of said objects.

21. The method of claim 1, wherein said creating step is carried out by at least one of a server of said virtual world and client software of a user of said virtual world.

22. The method of claim 1, wherein said inter action comprises:
obtaining input from a user of said virtual place, said user input specifying at least one of addition of, removal of, and rearrangement of said objects in said virtual place.

23. The method of claim 1, wherein said objects are associated with at least a second virtual world.

24. A computer program product comprising a computer useable medium including computer usable program code, said computer program product including:
computer usable program code for obtaining a specification of a set of objects associated with at least one virtual world;
computer usable program code for laying out said objects in a three-dimensional virtual representation; and
computer usable program code for creating an on-the-fly virtual place in said virtual world, based on said laying out step, said virtual place depicting said set of objects in said three-dimensional virtual representation and enabling navigation and interaction therewith.

25. A system comprising:
a memory; and
at least one processor, coupled to said memory, and operative to:
obtain a specification of a set of objects associated with at least one Virtual world;
lay out said objects in a three-dimensional virtual representation; and
create an on-the-fly virtual place in said virtual world, based on said laying out step, said virtual place depicting said set of objects in said three-dimensional virtual representation and enabling navigation and inter action therewith.
